(19) United States
(12) Patent Application Publication
(10) Pub. No.: US 2007/0082209 A1
(43) Pub. Date: Apr. 12, 2007

(54) Adhesion-promoting primer composition for non-olefin substrates

(76) Inventors: Kevin Alan Williams, Union, KY (US); Paul Michael Swan, Lancashire (GB)

Correspondence Address: Polly C. Owen;Eastman Chemical Company, P.O. Box 511, Kingsport, TN, 37662-5075, US

(21) Appl. No.: 11/516,266

(22) Filed: Sep. 6, 2006

Related U.S. Application Data
(60) Provisional application No. 60/725,606, filed on Oct. 11, 2005.

(51) Int. Cl. B32B 27/34; B32B 27/30; B32B 27/32

(52) U.S. Cl. 428/474.4; 428/475.5; 428/523; 428/522

(57) ABSTRACT

An adhesion-promoting coating composition that contains a carboxylated hydrocarbon polymer and a thermoplastic film-forming resin and exhibits enhanced adhesion-promoting properties, especially on non-olefin, fiber-reinforced substrates.

This application claims the benefit of U.S. Provisional Application Ser. No. 60/725,606, filed Oct. 11, 2005, fully incorporated herein by reference.

### FIELD OF THE INVENTION

This invention relates generally to adhesion-promoting coating compositions. In another aspect, the invention concerns improved adhesion-promoting coating compositions for use on non-olefin substrates.

### BACKGROUND OF THE INVENTION

Molded plastic parts are widely used in automobiles, trucks, household appliances, electronics devices, toys, and the like. Frequently, these plastic parts are made from a range of materials including styrenics, acrylics, polycarbonates, polyolefins, polyesters, polyamides (nylons), and other such engineering plastics. These polymers may also be blended with one another or with other additives in order to form a hybrid or a composite plastic. In order to obtain high strength at a relatively low weight, these composites may consist of a blend of the plastic resin with inorganic fillers. Inorganic fillers of particular interest include glass or mineral fibers which can align during the injection molding process used to prepare the plastic part to give remarkable dimensional stability to that part. One such hybrid that is of considerable interest for such applications, due to its cost/performance balance, is glass-filled nylon.

Glass-filled nylon is a generic term that is used to describe any number of combinations of polyamide (nylon) polymer compositions and glass filler, which is typically fibrous in nature. Typical polyamides are those known as nylon 6 or nylon 66 or blends thereof through combinations of these materials with specialty grade polyamides such as nylon 6T. The amount of glass in the composite can range from a few percent up to fifty percent or higher depending on the performance demands to be made on the final part.

Though one might intuitively think that obtaining adhesion of a coating to a relatively polar substrate like nylon would be straightforward, the heterogenous nature of even the simplest of these composite blends makes it difficult to obtain reproducible paint adhesion to the microscopic variations in composition across the surface of the plastic part. This surface heterogeneity can be further complicated by the tendency of some polyamide compositions to crystallize on cooling from the molding process, thereby creating a surface that is very difficult for coating solvents to swell or provide “bite” for the coating that is applied to the plastic.

One approach to improving the adherence of paint to non-olefin plastics (e.g., nylon) is to use an adhesion promoting primer composition as a separate primer coating between the non-olefin substrate and the paint. The adhesion promoting primer composition adheres adequately to both the non-olefin plastic and the paint and thereby creates a unitary three component structure with the paint as the outer portion of the structure. Alternatively, an adhesion promoting primer composition may be added directly to the paint as a “stir in” adhesion promoter.

Typically, these primers are carboxylate-modified hydrocarbon polymers (e.g., maleated polyolefins) which may or may not be modified further with a halogen (e.g., chlorine) in order to affect their solubility in typical coating solvents. While primers prepared from these materials provide some measure of basecoat/clearcoat adhesion to glass-filled nylon, adhesion failures still occur and can vary widely with basecoat/clearcoat system and/or substrate type.

In similar fashion, thermoplastic film-forming resins can as primers provide some adhesion to glass-filled nylon substrates though the level of adhesion can vary widely as the composition of the thermoplastic polymer changes. Often, initial adhesion may be marginal-to-acceptable, but when the coated article is subjected to environmental conditions such as moisture, the adhesion of the coating can deteriorate quickly. Furthermore, some thermoplastic film-forming resins, though perhaps adhering well to a substrate such as glass-filled nylon, could in fact impair the adhesion of subsequent coating layers to the substrate. For example, ethylene-vinyl acetate copolymers (EVAs) are widely used resin bases for hot melt, pressure-sensitive, and solvent-applied adhesives as well as in solvent-applied coatings. They are particularly useful in these applications when water-vapor and gas-barrier properties are of interest. However, EVA films, when extruded, provide a surface to which it is difficult to obtain coating adhesion, so much so that adhesion promoters such as the carboxylate-modified hydrocarbon polymers described above are often used in order to get coating formulations to adhere to the EVA film. As such, one would expect that EVAs would act as a poor primer for a difficult substrate, such as, glass-filled nylon, even if the EVA had good adhesion to the substrate simply because the subsequent coating layers would not adhere to an EVA primer. Furthermore, one would predict that the adhesion provided to a glass-filled nylon substrate by mixtures of carboxylate-modified hydrocarbon polymers and thermoplastic film-forming resins would be an average of the adhesion by those individual components related in large part to the relative amounts of each component in the mixture. Mixtures of these components, which provided for better coating adhesion to a substrate, such as, glass-filled nylon than either of the components individually, would be unexpected.

### SUMMARY OF THE INVENTION

Accordingly, it is an object of the present invention to provide an improved adhesion-promoting coating composition for use on substrates comprising non-olefin plastic and a reinforcing material.

In accordance with one embodiment of the present invention, there is provided an article comprising a substrate and an adhesion-promoting coating composition applied to the substrate. The substrate comprises a non-olefin plastic and a reinforcing material. The adhesion-promoting coating composition comprises a carboxylated hydrocarbon polymer and a thermoplastic film-forming resin.

In accordance with another embodiment of the present invention, there is provided a process comprising applying an adhesion-promoting coating composition to a substrate. The substrate comprises a non-olefin plastic and a reinforcing material. The adhesion-promoting coating composition comprises a carboxylated hydrocarbon polymer and a thermoplastic film-forming resin.

### DETAILED DESCRIPTION OF THE INVENTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, unless the patents or publications contradict the statements herein.

One embodiment of the present invention provides an adhesion-promoting coating composition comprising a carboxylated hydrocarbon polymer and an thermoplastic film-forming resin. Such adhesion-promoting coating composition is especially suited for use as an adhesion promoter on substrates comprising non-olefin plastics and a reinforcing material, as described in detail below.

As used herein, the term “carboxylate polymer(s)” includes carboxylated polymers that have or have not been halogenated and/or modified with a polyfunctional alcohol.

As used herein, the term “polymer(s)” includes homopolymers, copolymers, and/or terpolymers.

The carboxylated hydrocarbon polymer of the adhesion-promoting coating composition is typically prepared by reacting an initial hydrocarbon polymer with a carboxyl-containing compound.

The initial hydrocarbon polymer is preferably a polyolefin. Examples of polyolefins suitable for use as the initial hydrocarbon polymer of the present invention include ethylene copolymers prepared from ethylene and alpha olefins having 3 to about 10 carbon atoms, polypropylene, propylene copolymers prepared from ethylene or alpha olefins having from 4 to about 10 carbon atoms, poly(1-butene), 1-butene copolymers prepared from ethylene or alpha olefins having 3 to about 10 carbon atoms, and propylene terpolymers prepared from ethylene and/or alpha olefins having from 4 to about 10 carbon atoms. In addition, mixtures of the previously mentioned polyolefins may be employed. Preferably, the initial hydrocarbon polymer contains at least about 50 mole percent propylene.

Preferred copolymers suitable for use as the initial hydrocarbon polymer of the present invention include propylene-ethylene copolymers containing in the range of from about 70 to about 90 mole percent propylene and in the range of from about 10 to about 30 mole percent ethylene. Preferred terpolymers suitable for use as the initial hydrocarbon polymer of the present invention include propylene-butylene-ethylene terpolymers containing in the range of from about 55 to about 75 mole percent propylene, in the range of from about 15 to about 30 mole percent butylene, and in the range of from about 5 to about 25 mole percent ethylene.

Carboxyl-containing compounds suitable for use in the carboxylation of the initial hydrocarbon polymer include unsaturated carboxylic esters, unsaturated carboxylic acids, unsaturated carboxylic anhydrides, vinyl monomers, acrylic monomers, and combinations thereof. Examples of carboxyl-containing compounds useful in the carboxylation of the initial hydrocarbon polymer include, but are not limited to, maleic anhydride, citraconic anhydride, itaconic anhydride, glutaconic anhydride, 2,3-dimethylmaleic anhydride, maleic acid, fumaric acid, citraconic acid, mesaconic acid, glutaconic acid, acrylic acid, methacrylic acid, crotonic acid, 2-pentenoic acid, 2-methyl-2-pentenoic acid, dimethyl maleate, diethyl maleate, di-n-propyl maleate, diisopropyl maleate, dimethyl fumarate, diethyl fumarate, di-n-propyl fumarate, diisopropyl fumarate, dimethyl itaconate, methyl acrylate, hydroxyethyl acrylate, ethyl acrylate, methyl methacrylate, ethyl methacrylate, methyl crotonate, ethyl crotonate, hydroxyethyl acrylate, hydroxyethyl methacrylate, hydroxypropyl acrylate, hydroxypropyl methacrylate, and combinations thereof.

The carboxyl-containing compound can be readily grafted to the initial hydrocarbon polymer, in the solution or melt phase, using radical initiators such as organic peroxides and/or azo compounds. In one embodiment, the carboxyl-containing compound is grafted to the initial hydrocarbon polymer in a solution process according to the procedure described in U.S. Pat. No. 6,262,182, the entire disclosure of which is incorporated herein by reference. When employing such a solution process, it is preferred to employ solvents having relatively low boiling points because they are easier to remove via distillation. Preferred solvents include chlorobenzene (b.p. 132° C.), tert-butylbenzene (b.p. 169° C.), and anisole (b.p. 154° C.). Alternatively, the carboxyl-containing compound can be grafted to the initial hydrocarbon polymer in an extrusion process according to the procedure described in U.S. Pat. No. 6,046,279, the entire disclosure of which is incorporated herein by reference.

For grafting of the carboxyl-containing compound in the solution or melt phase, the reaction temperature is usually controlled by the half-life of the initiator. The half-life of the initiator at a given reaction temperature should be about one third to about one sixth of the reaction time. By knowing the half-life of the initiator at a specific temperature, a suitable reaction time can be quickly determined. The more stable the initiator, the longer the reaction time will be.

Suitable organic peroxides for use as initiators in the present invention include, but are not limited to, dibenzoyl peroxide, tert-amylperoxy 2-ethylhexanoate, tert-butylperoxy 2-ethylhexanoate, tert-butylperoxy isobutyrate, tert-butylperoxy isopropyl carbonate, tert-butylperoxy 3,3,5-trimethylhexanoate, 2,5-dimethyl-2,5-di(benzoylperoxy)hexane, tert-butylperoxy acetate, tert-butylperoxy benzoate, n-butyl 4,4-di(tert-butylperoxy)valerate, dicumyl peroxide, tert-butylcumyl peroxide, di(2-tert-butylperoxy isopropyl)benzene, 2,5-dimethyl-2,5-di(tert-butylperoxy)hexane, di(tert-butyl) peroxide, 2,5-dimethyl-2,5-di(tert-butylperoxy)-3-hexyne, tert-butyl hydroperoxide, cumyl hydroperoxide, and combinations thereof.

Suitable azo compounds for use as initiators in the present invention include, but are not limited to, 2,2′-azobisisopropionitrile, 2,2′-azobisisobutyronitrile (AIBN), dimethyl azoisobutyrate, 1,1′-azobis(cyclohexanecarbonitrile), 2,2′-azobis(2-methylpropane), and combinations thereof.

Preferably, the amount of the radical initiator employed in the carboxylating/grafting reaction ranges from about 0.1 to about 20 weight percent based on the weight of the initial hydrocarbon polymer. Most preferably, the range is from 0.2 to 10 weight percent.

The addition of the carboxyl-containing compound and the radical initiator can be carried out under numerous scenarios. For example, the carboxyl-containing compound can be added before the radical initiator, concurrent with the radical initiator, or subsequent to the radical initiator. The carboxyl-containing compound can be added in either the molten state, or as a solution in a solvent that does not interfere with the carboxylating or grafting reaction. Likewise, the radical initiator can be added in either solid or liquid form. It is also possible to charge a solution of the carboxyl-containing compound containing the initiator in a solvent that does not interfere with the desired reaction. The solvent used for this purpose can be the same as or different from the reaction solvent. The solvent preferably has a low volatility such that it flashes off and does not dilute or contaminate the reaction solvent. Preferred solvents for dissolving the carboxyl-containing compound include, but are not limited to, ketone solvents such as acetone and methyl ethyl ketone. In general, ketone solvents are used in amounts that do not cause the hydrocarbon polymer to precipitate.

The carboxylating/grafting process is typically conducted in solution at temperatures ranging from about 50° C. to about 300° C., depending on the choice of reaction solvent. The carboxylating reaction may be carried out at temperatures up to and including the boiling point of the reaction solvent. Most preferably, the temperature range is from 80° C. to 220° C. The carboxylating reaction may be conducted at pressures ranging from about 1 atmosphere to about 3 atmospheres.

Following the completion of the carboxylating/grafting reaction, the reaction product may be used as is, or optionally, the solvent used in the reaction may be removed by distillation at either ambient pressure, or more preferably, at reduced pressure. As a way of reducing cost in the process, the solvent may be recovered and recycled in subsequent batches. Solvents with relatively low boiling points are typically easier to remove and consequently more desirable for use in this process. Preferred solvents include tert-butylbenzene (b.p. 169° C.) and anisole (b.p. 154° C.).

The resulting carboxylated hydrocarbon polymer preferably contains in the range of from about 1 to about 25 weight percent of the carboxyl-containing compound, more preferably from about 2 to about 20 weight percent of the carboxyl-containing compound, and most preferably from 4 to 18 weight percent of the carboxyl-containing compound.

In one embodiment of the present invention, the carboxylated hydrocarbon polymer is further reacted with a halogen to form a halogenated, carboxylated hydrocarbon polymer. Preferably, the halogen is chlorine. If desired, the carboxylated hydrocarbon polymer may be halogenated in the same solvent in which the grafting of the carboxyl-containing compound to the initial hydrocarbon polymer was conducted (i.e., a “one-pot” preparation). Alternatively, solvent may be removed from the solution-grafted carboxylated hydrocarbon polymer and replaced with any suitable solvent for the reaction with the halogen. Carboxylated hydrocarbon polymers prepared via the extrusion process described above will typically be dissolved in a suitable solvent prior to the halogenation reaction. The carboxylated hydrocarbon polymers can be halogenated as described in U.S. Pat. No. 4,954,573, the entire disclosure of which is incorporated herein by reference. Alternatively, the carboxylated hydrocarbon polymers can be halogenated as described in U.S. Pat. No. 5,346,079, the entire disclosure of which is incorporated herein by reference. It should be noted that halogenated, carboxylated hydrocarbon polymer(s) useful in this invention can also be prepared by halogenating the hydrocarbon polymers prior to the introduction of the carboxyl-containing compound(s).

The halogenated, carboxylated hydrocarbon polymer preferably contains in the range of from about 1 to about 40 weight percent of the halogen, and most preferably in the range from 5 to 35 weight percent of the halogen.

The carboxylated, and optionally halogenated, hydrocarbon polymer may optionally be reacted with one or more polyfunctional alcohols (polyols). Suitable polyfunctional alcohols will have at least two hydroxyl groups or at least one hydroxyl group and another functional group capable of preferentially reacting with the carboxylated hydrocarbon polymer. When a polyfunctional alcohol group is used having at least two hydroxyl groups, it is preferred that at least one is a primary hydroxyl group and at least one is a secondary or tertiary hydroxyl group. When a polyfunctional alcohol group is used having at least one hydroxyl group and another functional group capable of preferentially reacting with the carboxylated hydrocarbon polymer, preferred non-hydroxyl reactive functional groups include amino, epoxy, and/or isocyanato.

Polyfunctional alcohols suitable for use in the present invention include, but are not limited to, trimethylolethane, pentaerythritol, trimethylolpropane, 1,6-hexanediol, 1,4-cyclohexanediol, 1,2-propylene glycol, 1,4-cyclohexanedimethanol, 2,2,4-trimethyl-1,3-pentanediol, 2-ethyl-1,3-hexanediol, 2-butyl-2-ethyl-1,3-propanediol, diethylene glycol, triethylene glycol, polyethylene glycols, glycerol, polyester polyols, acrylic polyols, polyurethanepolyols, glucose, sucrose, 2-amino-1-propanol, ethanolamine, 1,3-propylene glycol, neopentyl glycol, 2,2-dibutyl-1,3-propanediol, 2-methyl-2-propyl-1,3-propanediol, 2,2-diethyl-1,3-propanediol, ethylene glycol, 2-amino-2-methyl-1-propanol, tris(hydroxymethyl)methylamine, 2,2-dimethyl-3-amino-1-propanol, and combinations thereof. The amount of polyol used to modify the carboxylated hydrocarbon polymer will preferably be in the range of from about 0.01 to about 60 weight percent based on the weight of the carboxylated hydrocarbon polymer.

The reaction of the carboxylated hydrocarbon polymer with the polyfunctional alcohol may be carried out in the presence or absence of a solvent. When using a solvent, the reaction is preferably conducted at temperatures in the range of from about 10° C. to about 250° C. The reaction temperature chosen will affect the time necessary to complete the reaction. Exemplary solvents include aromatic hydrocarbon solvents, such as, benzene, toluene, xylene, tert-butylbenzene; chlorinated solvents, such as, chlorobenzene; aliphatic hydrocarbon solvents, such as, naphtha, mineral spirits, and hexane; and ester solvents, such as, propyl acetate and butyl acetate. Mixtures of the above solvents may be used if desired.

Optionally, the polyfunctional alcohol may be reacted with the carboxylated hydrocarbon polymer in the solvent used to prepare the carboxylated hydrocarbon polymer. Alternatively, solvent may be removed from the carboxylated hydrocarbon polymer and replaced with any suitable solvent for the reaction with the polyfunctional alcohol.

If the carboxylated hydrocarbon polymer contains anhydride groups, no catalyst is required to react this material with the polyfunctional alcohols to yield the corresponding monoester and half acid groups. However, a catalyst such as an alkyl or arylalkyl sulfonic acid may be used to increase the rate of reaction of the polyfunctional alcohol with the carboxylated hydrocarbon polymer. Also, if desired, the remaining half acid groups on the hydrocarbon polymer may then be further reacted with polyfunctional alcohol in the presence of excess polyfunctional alcohol and at a higher temperature to yield the corresponding diester. A catalyst may or may not be needed to completely esterify all of the half acid groups.

If the carboxylated hydrocarbon polymer is prepared by grafting an ester monomer, such as dimethyl maleate, to the hydrocarbon polymer, then it may be desirable to use a catalyst, such as a titanium catalyst, in order to facilitate the reaction of the polyfunctional alcohol with the carboxylated hydrocarbon polymer. Suitable titanium catalysts include titanium tetraisopropoxide, titanium tetraisobutoxide, and the like.

The thermoplastic film-forming resin component of the adhesion-promoting coating composition can be a polyurethane, an acrylic copolymer, a styrene-acrylic copolymer, an ethylene-vinyl acetate copolymer, or any combination thereof. In one preferred embodiment, the thermoplastic film-forming resin is an ethylene-vinyl acetate copolymer which contains in the range of from about 10 to about 50 weight percent vinyl acetate, and most preferably in the range of from 20 to 40 weight percent vinyl acetate. In another preferred embodiment, the thermoplastic film-forming resin is an aromatic polyurethane. In another preferred embodiment, the thermoplastic film-forming resin is an acrylic or styrene-acrylic copolymer with a glass transition of greater than or equal to 50° C. Suitable thermoplastic film-forming resins for use in the present invention include, but are not limited to, Elvax™ 260 and Elvax™ 40W, available from DuPont Chemical, Uraflex EU86, available from DSM Resins, and Paraloid DM55 available from Rohm and Haas.

The carboxylated hydrocarbon polymer and thermoplastic film-forming resin components of the inventive adhesion-promoting coating composition can be combined in any manner to yield an adhesion-promoting coating composition in the desired form. The form of the adhesion-promoting coating composition can vary greatly depending on its intended use. However, regardless of the final form, it is preferred for the carboxylated hydrocarbon polymer-to-thermoplastic film-forming resin weight ratio of the adhesion-promoting coating composition to be in the range of from about 1:8 to about 8:1, more preferably in the range of from about 1:4 to about 4:1, and most preferably in the range of from 1:1.5 to 1.5:1.

In one embodiment, the adhesion-promoting coating composition is a dilute solution comprising the carboxylated hydrocarbon polymer and the thermoplastic film-forming resin dissolved in a suitable solvent. This dilute form of the adhesion-promoting coating composition can be directly applied to a substrate as a primer. Examples of suitable solvents include toluene, xylene, naphtha, mineral spirits, hexane, ester solvents (e.g., propyl acetate and butyl acetate), ketones (e.g., methyl amyl ketone), and combinations thereof. The solvent component of this dilute adhesion-promoting coating composition preferably comprises at least one aromatic hydrocarbon solvent. Particularly preferred solvents include toluene, xylene, and combinations thereof. Most preferably, the solvent is toluene.

In the diluted form of the adhesion-promoting coating composition, it is preferred for the carboxylated hydrocarbon polymer and the thermoplastic film-forming resin to each be present in an amount in the range of from about 0.5 to about 40 weight percent, more preferably in the range of from about 2 to about 25 weight percent, and most preferably in the range of from 4 to 15 weight percent.

In accordance with one embodiment of the present invention, the diluted adhesion-promoting coating composition described above is applied as a coating to a substrate comprising a non-olefin plastic and a reinforcing material. The substrate preferably contains at least about 5 weight percent of the reinforcing material and at least about 25 weight percent of the non-olefin plastic, more preferably in the range of from about 10 to about 60 weight percent of the reinforcing material and about 40 to about 90 weight percent of the non-olefin plastic, and most preferably in the range of from 15 to 40 weight percent of the reinforcing material and 60 to 85 weight percent of the non-olefin plastic. Preferably, the non-olefin plastic is a polyamide, and most preferably nylon. The reinforcing material is preferably present in the form of a fiber or a mineral filler interspersed in the non-olefin plastic. It is preferred that reinforcing fibers are glass or carbon fibers. Most preferably, the reinforcing material is glass fibers, and the substrate is glass-filled nylon. The substrate may also contain minor amounts of other additives known in the art such as UV stabilizers, impact modifiers, flame retardants, lubricants, heat stabilizers, and the like. One example of a suitable commercially available glass-filled nylon substrate is Solvay IXEF™ 1622, available from Solvay Advanced Polymers, L.L.C., Alpharetta, Ga.

The dilute adhesion-promoting coating composition of the present invention is especially useful as a primer for coating substrates as described above which suffer from poor paint adhesion. Accordingly, the dilute adhesion promoting coating composition may be applied to a reinforced non-olefin substrate as described above, allowed to dry, and a conventional topcoat composition applied thereto. The conventional topcoat composition may be either waterborne or solventborne. Alternatively, the adhesion-promoting coating composition of the present invention may be blended with various basecoat compositions to afford a self-priming composition useful for coating various reinforced non-olefin substrates, described previously. In this regard, such basecoat compositions may be any coating composition, typically comprised of any number of traditional resins, for example, polyesters, acrylics, styrene-acrylics, urethanes, alkyds, or blends thereof. In addition, such adhesion-promoting coating compositions may also further comprise one or more typical coatings additives such as leveling, rheology, and flow control agents (e.g., silicones, fluorocarbons or cellulosics); microgels; thickeners; flatting agents; pigment wetting and dispersing agents and surfactants; ultraviolet (“UV”) absorbers; UV light stabilizers; tinting pigments; defoaming and antifoaming agents; anti-settling, anti-sag, and bodying agents; anti-skinning agents; anti-flooding and anti-floating agents; fungicides and mildewcides; corrosion inhibitors; plasticizers; or coalescing agents.

Specific examples of such additives can be found in Raw Materials Index, published by the National Paint & Coatings Association, 1500 Rhode Island Avenue, N.W., Washington, D.C. 20005.

Examples of flatting agents include synthetic silica, available from the Davison Chemical Division of W. R. Grace & Company under the trademark SYLOID; polypropylene, available from Hercules Inc., under the trademark HERCOFLAT; and synthetic silicate, available from J. M. Huber Corporation under the trademark ZEOLEX.

Examples of dispersing agents and surfactants include sodium bis(tridecyl) sulfosuccinnate, di(2-ethylhexyl) sodium sulfosuccinnate, sodium dihexylsulfosuccinnate, sodium dicyclohexyl sulfosuccinnate, diamyl sodium sulfosuccinnate, sodium diisobutyl sulfosuccinnate, disodium iso-decyl sulfosuccinnate, disodium ethoxylated alcohol half ester of sulfosuccinnic acid, disodium alkyl amido polyethoxy sulfosuccinnate, tetrasodium N-(1,2-dicarboxy-ethyl)-N-octadecyl sulfosuccinnamate, and disodium N-octasulfosuccinnamate.

Examples of viscosity, suspension, and flow control agents include polyaminoamide phosphate, high molecular weight carboxylic acid salts of polyamine amides, and alkylene amine salts of an unsaturated fatty acid, all available from BYK Chemie U.S.A. under the trademark ANTI TERRA. Further examples include polysiloxane copolymers, polyacrylate solution, cellulose esters, hydroxyethyl cellulose, hydrophobically-modified hydroxyethyl cellulose, hydroxypropyl cellulose, polyamide wax, polyolefin wax, and polyethylene oxide.

Several proprietary antifoaming agents are commercially available, for example, under the trademark BRUBREAK of Buckman Laboratories Inc., under the BYK trademark of BYK Chemie, U.S.A., under the FOAMASTER and NOPCO trademarks of Cognis, under the DREWPLUS trademark of the Drew Industrial Division of Ashland Chemical Company, under the TROYSOL and TROYKYD trademarks of Troy Chemical Corporation, and under the SAG trademark of Dow Chemical Company.

Examples of fungicides, mildewcides, and biocides include 4,4-dimethyloxazolidine, 3,4,4-trimethyloxazolidine, modified barium metaborate, potassium N-hydroxy-methyl-N-methyldithiocarbamate, 2-(thiocyanomethylthio) benzothiazole, potassium dimethyl dithiocarbamate, adamantane, N-(trichloromethylthio) phthalimide, 2,4,5,6-tetrachloroisophthalonitrile, orthophenyl phenol, 2,4,5-trichlorophenol, dehydroacetic acid, copper naphthenate, copper octoate, organic arsenic compounds, tributyl tin oxide, zinc naphthenate, and copper 8-quinolinate.

Examples of U.V. absorbers and U.V. light stabilizers include substituted benzophenones, substituted benzotriazoles, hindered amines, and hindered benzoates, available from Cytec Industries under the trademark CYASORB UV, and diethyl-3-acetyl-4-hydroxy-benzyl-phosphonate, 4-dodecyloxy-2-hydroxy benzophenone, and resorcinol monobenzoate.

Such paint or coating additives as described previously form a relatively minor proportion of the coating composition, preferably about 0.05 weight percent to about 5.00 weight percent.

As a further aspect of the present invention, there is provided an adhesion-promoting coating composition as set forth previously, further comprising one or more pigments and/or fillers in a concentration of about 0.5 to about 50 weight percent, preferably about 5 to about 30 weight percent, based on the total weight of the components of the composition.

Pigments suitable for use in the coating compositions envisioned by the present invention are the typical organic and inorganic pigments, well-known to one of ordinary skill in the art of surface coatings, especially those set forth by the Colour Index, 3d Ed., 2d Rev., 1982, published by the Society of Dyers and Colourists in association with the American Association of Textile Chemists and Colorists. Examples include, but are not limited to the following: CI Pigment Black 7 (carbon black), CI Pigment White 6 (titanium dioxide); CI Pigment Red 101 (red iron Oxide); CI Pigment Yellow 42, CI Pigment Blue 15, 15:1, 15:2, 15:3, 15:4 (copper phthalocyanines); CI Pigment Red 49:1; and CI Pigment Red 57:1.

The adhesion-promoting coating compositions of the present invention as well as their aforementioned blends with conventional coating formulations to form self-priming compositions may be applied to the substrate by spray application, dipping, or any other means available, which allows for a uniform coating of the adhesion-promoting coating composition onto the reinforced non-olefin substrate.

This invention can be further illustrated by the following examples of preferred embodiments thereof, although it will be understood that these examples are included merely for purposes of illustration and are not intended to limit the scope of the invention.

### EXAMPLE 1

### Preparation of Adhesion-Promoting Primers

Adhesion-promoting primers (A-K) were prepared, and are summarized in Table 1, below.

TABLE 1

| | Carboxylated | | | Solvent Used |
|---|---|---|---|---|
| | Hydrocarbon | EVA/ | | to |
| | Polymer | Polyurethane | Polyolefin-to- | Dilute to 5% |
| Primer | Component | Component | EVA Ratio | Solids |
| A | CP 343-1 | — | — | Toluene |
| B | CP 164-1 | — | — | Toluene |
| C | CP 730-1 | — | — | Toluene |
| D | AP 550-1 | — | — | Toluene |
| E | CP 343-3 | — | — | Toluene |
| F | — | ELVAX 260 | — | 50/50 |
| | | | | Toluene/Xylene |
| G | CP 343-1 | ELVAX 260 | 1:1 | Toluene |
| H | CP 730-1 | ELVAX 260 | 1:1 | Toluene |
| I | CP 164-1 | ELVAX 260 | 1:1 | Toluene |
| J | CP 343-3 | ELVAX 260 | 1:1 | Toluene |
| K | AP 550-1 | ELVAX 260 | 1:1 | Toluene |

The carboxylated hydrocarbon polymer components listed above in Table 1 are all commercially available adhesion promoters supplied by Eastman Chemical Company of Kingsport, Tenn. ELVAX™ 260 is a commercially available EVA supplied by DuPont Company of Wilmington, Del.

Primers A-E were prepared by diluting the commercially available adhesion promoters with toluene to a concentration of 5 percent carboxylated hydrocarbon polymer. Primer F was prepared by diluting ELVAX™ 260 with a 50% toluene/50% xylene solvent to a concentration of 5 percent EVA. Primers G-K were prepared by blending the carboxylated hydrocarbon polymer and EVA in amounts that provided a 1:1 weight ratio of the carboxylated hydrocarbon polymer and EVA components based on solids. The resulting blended carboxylated hydrocarbon polymer/EVA intermediate was then diluted with toluene to a concentration of 5 percent carboxylated hydrocarbon polymer+EVA.

### EXAMPLE 2

### Preparation of Coating Articles

Adhesion-promoting primers (A-K) were applied to test panel substrates, dried, and then topcoated to form coated articles which could thereafter be tested for topcoat adhesion.

The test panel substrates were Solvay IXEF™ 1622/9003 glass filled nylon supplied by Solvay Advanced Polymers, L.L.C. of Alpharetta, Ga. Two types of topcoatings (basecoat+clearcoat) were used: (1) Supplier 1 Refinish 1K silver metallic basecoat/Refinish 2K urethane semi-gloss clearcoat; and (2) Supplier 2 Refinish 1K silver metallic basecoat/Refinish 2K urethane clearcoat.

Prior to application of the primers to the test panel substrates, the test panel substrates were wiped clean with isopropyl alcohol and allowed to dry in air. Two coats of the primers were then spray applied (30-40 lbs pressure) to the substrates to a final dry film thickness (DFT) of approximately 5-10 microns. The primer layers were air dried for 10-15 minutes.

The topcoatings, described previously, were spray applied to the primed test panels and then flash dried for 15 minutes prior to oven curing. The coated test panels were cured in a laboratory oven for 30 minutes at 80° C. After curing in the oven, the coated test panels were stored at room temperature for one day and then tested for 2 mm crosshatch adhesion, as described subsequently. After storing for one week, the 1 mm crosshatch adhesion test, described subsequently, was performed.

### EXAMPLE 3

### Testing of the Coated Articles

Initial adhesion tests were performed on the coated test panels in accordance with the cross-cut tape test set forth in ASTM 3359 Method B. In this test, the coated test panels were scribed with a sharp knife to make 25 squares. The center of a piece of tape was placed over the scribed area and the tape was rubbed firmly into place with a pencil eraser. The tape was removed by seizing the free end and rapidly peeling it back on itself as close to a 90-degree angle as possible. The percent paint retained was then determined. This test was performed using both 2 mm and 1 mm crosscuts in the coating.

The results of the 2 mm and 1 mm crosscut initial adhesion tests for primers A-K and the two topcoats are summarized below in Table 2.

TABLE 2

| | | % | % | % | % |
|---|---|---|---|---|---|
| | | Retained | Retained | Retained | Retained |
| Prim- | Primer | (2 mm) | (1 mm) | (2 mm) | (1 mm) |
| er | Components | Topcoat 1 | Topcoat 1 | Topcoat 2 | Topcoat 2 |
| A | CP 343-1/none | 85* | 60* | 85* | 0 |
| B | CP 164-1/none | 80* | 10* | 95 | 15 |
| C | CP 730-1/none | 85* | 95 | 50 | 0 |
| D | AP 550-1/none | 95* | 75* | 100* | 95* |
| E | CP 343-3/none | 95* | 90* | 90* | 0 |
| F | none/Elvax 260 | 60* | 0 | 10 | 0 |
| G | CP 343-1/Elvax | 100* | 98* | 100 | 98* |
| | 260 | | | | |
| H | CP 730-1/Elvax | 98* | 95* | 100* | 97* |
| | 260 | | | | |
| I | CP 164-1/Elvax | 100 | 100 | 100 | 99* |
| | 260 | | | | |
| J | CP 343-3/Elvax | 90* | 75* | 98* | 75* |
| | 260 | | | | |
| K | AP 550-1/Elvax | 98* | 95* | 100* | 98* |
| | 260 | | | | |

*= minor adhesion loss when making crosshatch cut into the substrate
Two types of topcoatings (basecoat + clearcoat) were used: Topcoat 1 Supplier 1 Refinish 1K silver metallic basecoat/Refinish 2K urethane semi-gloss clearcoat; and Topcoat 2 Supplier 2 Refinish 1K silver metallic basecoat/Refinish 2K urethane clearcoat.

The test results summarized in Table 2 demonstrate that, when applied to a glass-filled nylon substrate, adhesion-promoting primers containing a blend of a carboxylated hydrocarbon polymer and a thermoplastic film-forming resin (i.e., Primers G-K) such as EVA generally have superior adhesion-promoting properties versus adhesion promoting primers containing only the carboxylated hydrocarbon polymer (i.e., Primers A-E) and the adhesion promoting primer containing only a thermoplastic film-forming resin (i.e., Primer F).

### EXAMPLE 4

A series of adhesion-promoting primers (L-R) were prepared at 5% solids in xylene and spray applied to test panel substrates of Zytel HTN53G50LR from DuPont Chemical of Wilmington, DE to yield a final DFT of approximately 5 microns. The adhesion-promoting primers were allowed to flash for 10 minutes at room temperature. A commercial 1K metallic basecoat was then applied to yield a final DFT of 10-11 microns, flashed at room temperature for 10 minutes, and then cured at 80° C. for 20 minutes. A commercial 2K clearcoat was then applied to yield a final DFT of 20-22 microns, flashed at room temperature for 5 minutes, and cured at 80° C. for 30 minutes.

The resulting coated test panels were tested for adhesion as follows:

Crosshatch Adhesion—Initial adhesion was determined within one day following the curing process by scribing the coating with a 1 mm crosshatch grid and then conducting a tape peel test as described previously. Adhesion after water-soak was determined by first soaking the coated panel in water for eight days, allowing the coating to recover for one hour. The coating was then scribed with a 1 mm crosshatch grid, and a tape peel test for adhesion was conducted as described previously. Adhesion is reported as percent of the coating retained on the reinforced non-olefin substrate.

Blister Adhesion—The adhesion of the coating as measured by its propensity to blister on immersion in water was evaluated using ASTM D7-14.

Modified Karcher Adhesion—Panels were scribed with a single horizontal cut. A high pressure stream of water (70° C., 67 bar, Karcher nozzle EG25065) was directed at the scribe area from a distance of 10 cm for one minute. Adhesion was evaluated and expressed as area (in mm²) of substrate exposed. Therefore, a lower number indicates better overall adhesion.

TABLE 3

| | | | Water-Soak | | |
|---|---|---|---|---|---|
| | | | | Crosshatch | |
| | | Initial | | Adhesion | |
| | | Crosshatch | Time - | 1 Hour | Karcher |
| | Resin 1/- | Adhesion | Blister | Recovery | mm² |
| Primer | Resin 2* | % retained | Rating | % retained | removed |
| L | CP343-1/- | 100 | 8F (3 | 0 | 5 |
| | none | | days) | | |
| M | CP343-1/- | 100 | none (8 | 100 | 6 |
| | Elvax 260 | | days) | | |
| N | AP550-1/- | 100 | 8F (8 | 30 | 235 |
| | none | | days) | | |
| O | AP550-1/- | 100 | 8F (1 | 80 | 25 |
| | Elvax 260 | | day) | | |
| P | CP343-1/- | 100 | 8F (8 | 100 | 0 |
| | Paraloid | | days) | | |
| | DM55 | | | | |
| Q | none/Uraflex | 90 | 8F (1 | 90 | 1 |
| | EU86 | | day) | | |
| R | CP343-1/- | 100 | none (8 | 100 | 0 |
| | Uraflex | | days) | | |
| | EU86 | | | | |

*resins are blended 1:1
CP343-1 and AP550-1 are supplied by Eastman Chemical Company
Elvax 260 is supplied by DuPont Chemical
Uraflex EU86 is supplied by DSM Resins
Paraloid DM55 is supplied by Rohm and Haas

The test results summarized in Table 3 demonstrate that, when applied to a glass-filled nylon substrate, adhesion promoting primers containing a blend of a carboxylated hydrocarbon polymer and a thermoplastic film-forming resin (Primers M, O, P, and R) generally have superior adhesion-promoting properties versus adhesion promoting primers containing only the carboxylated hydrocarbon polymer (i.e., Primers L and N) and the adhesion promoting primer containing the thermoplastic film-forming resin (Primer Q).

### EXAMPLE 5

A series of adhesion-promoting primers (S-Z) were prepared at 5% solids in xylene and spray applied to test panel substrates of Grilamid LV-5H Schwarz 9288 from EMS Chemie (UK) Ltd. to yield a final DFT of approximately 5 microns. The primers were allowed to flash for 10 minutes at room temperature. A commercial 1K metallic basecoat was then applied to yield a final DFT of 10-11 microns, flashed at room temperature for 10 minutes, and then cured at 80° C. for 20 minutes. A commercial 2K clearcoat was then applied to yield a final DFT of 20-22 microns, flashed at room temperature for 5 minutes, and cured at 80° C. for 30 minutes.

The resulting coated test panels were tested for adhesion as detailed above.

TABLE 4

| | | | Water-Soak | | |
|---|---|---|---|---|---|
| | | | | Crosshatch | |
| | | Initial | | Adhesion | |
| | | Crosshatch | Time - | 1 Hour | Karcher |
| | Resin 1/ | Adhesion % | Blister | Recovery | mm² |
| Primer | Resin 2* | retained | Rating | % retained | removed |
| S | CP 343-1/ | 100 | None | 35 | 28 |
| | Elvax 260 | | | | |
| T | CP 730-1/ | 100 | None | 100 | 33 |
| | Elvax 260 | | | | |
| U | CP 343- | 100 | None | 100 | 336 |
| | 1/Paraloid | | | | |
| | DM55 | | | | |
| V | CP 343- | 100 | None | 100 | 214 |
| | 1/Uraflex | | | | |
| | EU86 | | | | |
| W | Paraloid | 80 | None | 0 | 439 |
| | DM55 | | | | |
| X | Elvax 260 | 70 | None | 95 | 415 |
| Y | CP 343-1 | 0 | None | 0 | 300 |
| Z | CP 730-1 | 100 | None | 100 | 101 |

*resins are blended 1:1
CP343-1 and CP730-1 are supplied by Eastman Chemical Company
Elvax 260 is supplied by DuPont Chemical
Uraflex EU86 is supplied by DSM Resins
Paraloid DM 55 is supplied by Rohm and Haas

The test results summarized in Table 4 demonstrate that, when applied to a glass-filled nylon substrate, adhesion-promoting primers containing a blend of a carboxylated hydrocarbon polymer and a thermoplastic film-forming resin (Primers S, T, U, and V) generally have superior adhesion-promoting properties versus adhesion-promoting primers containing only the carboxylated hydrocarbon polymer (i.e., Primers Y and Z) and the adhesion promoting-primers containing the thermoplastic film-forming resin (Primers W and X).

That which is claimed is:

1. An article comprising: a substrate comprising a non-olefin plastic and at least one reinforcing material; and an adhesion-promoting coating composition applied to said substrate, wherein said adhesion-promoting coating composition comprises a carboxylated hydrocarbon polymer and a thermoplastic film-forming resin.

2. The article of claim 1 wherein said substrate contains fibers of said reinforcing material interspersed in said non-olefin plastic.

3. The article of claim 2 wherein said substrate contains at least about 5 weight percent of said fibers.

4. The article of claim 1 wherein said at least one reinforcing material is selected from a group comprising glass fiber, carbon fiber, and talc.

5. The article of claim 1 wherein said non-olefin plastic comprises a polyamide.

6. The article of claim 5 wherein said polyamide is a nylon.

7. The article of claim 1 wherein said carboxylated hydrocarbon polymer comprises a polyolefin.

8. The article of claim 7 wherein said polyolefin is selected from the group consisting of ethylene copolymers prepared from ethylene and alpha olefins having 3 to about 10 carbon atoms, polypropylene, propylene copolymers prepared from ethylene or alpha olefins having from 4 to about 10 carbon atoms, poly( 1-butene), 1-butene copolymers prepared from ethylene or alpha olefins having 3 to about 10 carbon atoms, propylene terpolymers prepared from ethylene and/or alpha olefins having from 4 to about 10 carbon atoms, and combinations thereof.

9. The article of claim 1 wherein said carboxylated hydrocarbon polymer comprises a carboxyl-containing compound selected from the group consisting of unsaturated carboxylic acid esters, unsaturated carboxylic acids, unsaturated carboxylic anhydrides, vinyl monomers, acrylic monomers, and combinations thereof.

10. The article of claim 9 wherein said carboxyl-containing compound is selected from the group consisting of maleic anhydride, citraconic anhydride, itaconic anhydride, glutaconic anhydride, 2,3-dimethylmaleic anhydride, maleic acid, fumaric acid, citraconic acid, mesaconic acid, glutaconic acid, acrylic acid, methacrylic acid, crotonic acid, 2-pentenoic acid, 2-methyl-2-pentenoic acid, dimethyl maleate, diethyl maleate, di-n-propyl maleate, diisopropyl maleate, dimethyl fumarate, diethyl fumarate, di-n-propyl fumarate, diisopropyl fumarate, dimethyl itaconate, methyl acrylate, hydroxyethyl acrylate, ethyl acrylate, methyl methacrylate, ethyl methacrylate, methyl crotonate, ethyl crotonate, hydroxyethyl acrylate, hydroxyethyl methacrylate, hydroxypropyl acrylate, hydroxypropyl methacrylate, and combinations thereof.

11. The article of claim 10 wherein said carboxylated hydrocarbon polymer contains in the range of from about 1 to about 25 weight percent of said carboxyl-containing compound.

12. The article of claim 1 wherein said carboxylated hydrocarbon polymer comprises a halogen.

13. The article of claim 12 wherein said halogen is chlorine.

14. The article of claim 12 wherein said carboxylated hydrocarbon polymer contains said halogen in an amount in the range of from about 1 to about 40 weight percent.

15. The article of claim 1 wherein said carboxylated hydrocarbon polymer has been modified with a polyfunctional alcohol.

16. The article of claim 15 wherein said polyfunctional alcohol has at least one of the following properties: (i) at least two hydroxyl groups or (ii) at least one hydroxyl group and at least one other functional group.

17. The article of claim 16 wherein said polyfunctional alcohol is selected from the group consisting of trimethylolethane, pentaerythritol, trimethylolpropane, 1,6-hexanediol, 1,4-cyclohexanediol, 1,2-propylene glycol, 1,4-cyclohexanedimethanol, 2,2,4-trimethyl-1,3-pentanediol, 2-ethyl-1,3-hexanediol, 2-butyl-2-ethyl-1,3-propanediol, diethylene glycol, triethylene glycol, polyethylene glycols, glycerol, polyester polyols, acrylic polyols, polyurethanepolyols, glucose, sucrose, 2-amino-1-propanol, ethanolamine, 1,3-propylene glycol, neopentyl glycol, 2,2-dibutyl-1,3-propanediol, 2-methyl-2-propyl-1,3-propanediol, 2,2-diethyl-1,3-propanediol, ethyleneglycol, 2-amino-2-methyl-1-propanol, tris(hydroxymethyl)methylamine, 2,2-dimethyl-3-amino-1-propanol, and combinations thereof.

18. The article of claim 1 wherein said thermoplastic film-forming resin is selected from the group consisting of ethylene-vinyl acetate copolymers, polyurethanes, acrylic copolymers, and styrene-acrylic copolymers.

19. The article of claim 18 wherein said thermoplastic film-forming resin is an ethylene-vinyl acetate copolymer which contains in the range of from about 10 to about 50 weight percent vinyl acetate.

20. The article of claim 1 wherein said adhesion-promoting coating composition has a carboxylated hydrocarbon polymer-to-thermoplastic film-forming resin weight ratio in the range of from about 1:8 to about 8:1; or in the range of from about 1:4 to about 4:1; or in the range of about 1:1.5 to about 1.5:1.
